(19) United States
(12) Patent Application Publication
(10) Pub. No.: US 2020/0053436 A1
(43) Pub. Date: Feb. 13, 2020

(54) Electromagnetic Meter Coupling

(71) Applicant: Arad Measuring Technologies Ltd., Yokneam Elit (IL)

(72) Inventors: Snir Azulay, Tiberius (IL); Yoav Tov, Kefar Yona (IL)

(21) Appl. No.: 16/531,385

(22) Filed: Aug. 5, 2019

Related U.S. Application Data
(60) Provisional application No. 62/717,281, filed on Aug. 10, 2018.

(51) Int. Cl. H04Q 9/00

(52) U.S. Cl. CPC H04Q 9/00; H04Q 2209/40

(57) ABSTRACT

A coupler device for a meter reading system includes a housing defining a hollow interior, the housing being configured to be positioned on an end unit of the meter reading system; and an electromagnetic coupler positioned within the hollow interior of the housing. The electromagnetic coupler is configured to form an electromagnetic coupling with the end unit. The housing is configured to engage the end unit to form a sealed gap between the electromagnetic coupler and the end unit.

### CROSS REFERENCE TO RELATED APPLICATION

The present application claims priority to U.S. Provisional Patent Application No. 62/717,281, filed on Aug. 10, 2018, which is incorporated herein by reference in its entirety.

### BACKGROUND OF THE INVENTION

### Field of the Invention

The present invention relates to a coupler device for an end unit of a meter reading system. More particularly, the present invention relates to a coupler device forming a sealed gap between the end unit and an electromagnetic coupler disposed within the coupler device.

### Description of Related Art

Presently, many locales visually read utility meters to determine utility consumption. The meters, such as water meters, include an odometer that identifies the consumption of the water consumed. The odometer is read periodically, and the difference between the present and the prior reading determines the amount of utility water used. For example, if the most recent water meter reading was 2 million gallons or liters and the previous water meter reading was 1.8 million gallons or liters, then 200,000 gallons or liters of water were consumed. This procedure of individually reading water meters is time consuming, labor intensive, and expensive. In a competitive market, such an expense affects profitability to the utility provider. This is especially a problem in submetering markets where a separate entity may have to be employed to read water meters in apartment buildings and apartment building complexes.

Subsequently, meter reading systems have evolved whereby they are connected to telephone lines and/or transmitters which transmit radio waves to a central location. In many instances, this eliminates many of the problems associated with utility consumption reading. For example, Automatic Meter Reading (AMR) systems have been developed based on wireless networks. Such AMR systems typically include an end unit (EU) and a Collector Unit (CU). The EU measures the water flow and water consumption at the entrance point of houses, offices, or any civilian or industrial construction with a water connection. The EU accurately measures the water flow in a pipe and transmits the measured data to the CU using a radio frequency transmitter. Examples of such AMR systems can be found in United States Patent Application Publication No. 2012/0191380 and U.S. Pat. Nos. 8,109,131 and 6,819,292, all of which are hereby incorporated by reference in their entireties.

There are many types of EU installations. For instance, the EU can be positioned within the basement of a house or outside of a house mounted on a pipe. In addition, in moderate climate zones, the EU is located in a subsurface ground enclosure in an area near residences or other dwellings. Such enclosures are referred to as “pits”. However, the presence of obstacles (buildings, hills, trees, cars, etc.) between the EU installation and the CU, particularly the positioning of a utility meter in such a pit, causes various limitations when the utility meter is used as part of an AMR system. Data is transferred wirelessly between the EU and the CU in both directions, and the electromagnetic signal tends to fade as the distance between the EU and the CU is increased or if an obstacle is present between the EU and the CU. The installation of the utility meter and the EU in a pit further degrades the connection between the EU and the CU, because the radio wave signals of the antenna cannot radiate a great distance due to the properties of the pit. Further, in some instances, the pit may fill with water, further hampering the transmission capability of the antenna.

### SUMMARY OF THE INVENTION

According to an example of the present disclosure, an electromagnetic coupler device is provided, primarily for use in pits and other areas and structures that may obstruct transmission between end units and collector units of an AMR system. The electromagnetic coupler device attaches to a meter register of an end unit for transmission. The register includes a lens cap and metal cup that form a sealed, closed register. The register has a cylindrical shape. The coupler device is made as a three-dimensional torus, which includes a polymer closure and printed circuit board (PCB) arrangement incorporating an arcuate antenna. The antenna utilized on the register is substantially cylindrical, which enables the coupler antenna to maximize connectivity. The coupler device forms a sealed unit with the antenna contained within a torus body. The closure of the coupler device is filled with air, which surrounds the arcuate antenna. An inner surface of the torus body forms a sealed cavity between the register outer surface and the coupling inner surface. One arrangement that can be utilized to form this watertight sealed arrangement is through the use of O-rings. The coupler can be a passive antenna arrangement or an active antenna arrangement including a power source. A coax cable is provided with the coupler to engage with an external antenna for transmitting readings, if necessary. The antenna of the coupler device may be a dual-band antenna such that the antenna can match with a dual-band antenna of the meter register.

According to a particular example of the present disclosure, a coupler device for a meter reading system is provided. The coupler device comprises a housing defining a hollow interior, the housing being configured to be positioned on an end unit of the meter reading system; and an electromagnetic coupler positioned within the hollow interior of the housing, the electromagnetic coupler being configured to form an electromagnetic coupling with the end unit. The housing is configured to engage the end unit to form a sealed gap between the electromagnetic coupler and the end unit. The hollow interior of the housing may be sealed.

According to the example, the housing has a substantially toroidal shape and is configured to be positioned on the end unit so as to surround the end unit. The housing may include an upper cap and a lower cap, and the upper cap and lower cap are sealingly engaged to each other to define the hollow interior. The toroidal shape of the housing defines an inner surface of the housing, and the inner surface of the housing is configured to sealingly engage the end unit to form the sealed gap. The electromagnetic coupler may have an annular ring shape and be configured to extend within the hollow interior of the housing completely around the end unit.

The coupler device may further include a coaxial cable connected to the electromagnetic coupler and extending from the housing, wherein the coaxial cable is configured to place the electromagnetic coupler in communication with an external antenna. The electromagnetic coupler may include a passive antenna or an active antenna. The electromagnetic coupler may include a dual-band antenna configured to form a frequency match with an antenna of the end unit.

These and other features and characteristics of the present invention, as well as the methods of operation and functions of the related elements of structures, and the combination of parts and economies of manufacture, will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” includes plural referents unless the context clearly dictates otherwise.

### BRIEF DESCRIPTION OF THE DRAWINGS

FIG. 1 is a front view of an assembled end unit and coupler device of a meter reading system according to an example of the present disclosure;

FIG. 2 is a perspective view of the assembled end unit and coupler device of FIG. 1 with portions of the end unit and coupler device housings removed to illustrate internal components;

FIG. 3 is a perspective view of the assembled end unit and coupler device of FIG. 1 with additional portions of the housings removed to illustrate internal components;

FIG. 4 is a perspective view of the assembled end unit and coupler device of FIG. 1 with additional portions of the housings removed to illustrate internal components;

FIG. 5 is an exploded side view of an assembly of the end unit of FIG. 1;

FIG. 6 is an exploded side view of an assembly of the coupler device of FIG. 1;

FIG. 7 is an exploded perspective view of the assembly of the coupler device of FIG. 1;

FIG. 7B is a sectional view of a portion of the coupler device and the meter reading system shown in FIG. 1, showing a sealed gap;

FIG. 8 is a schematic of a two port network according to an example of the present disclosure;

FIG. 9 is a scattering matrix for the two port network according to the example of FIG. 8;

FIG. 10 is a schematic of an end unit and an electromagnetic coupler in the two port network according to the example of FIG. 8;

FIG. 11 is a chart illustrating the performance of the end unit and electromagnetic coupler in the two port network according to the example of FIG. 8 in a free space;

FIG. 12 is a chart illustrating the performance of the end unit and electromagnetic coupler in the two port network according to the example of FIG. 8 in a water-filled space; and

FIG. 13 is a schematic of an end unit and an electromagnetic coupler connected to an external antenna according to an example of the present disclosure.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

### Introduction

As discussed above, when a utility meter and an end unit of an Automatic Meter Reading (AMR) system is disposed within a pit, the quality of the wireless connection between the end unit and a collector unit is negatively affected. The presence of standing water within the pit further degrades quality of the connection between the end unit and the collector unit.

Several solutions have previously been implemented to improve wireless connectivity between the end unit and the collector unit. One solution has been to increase the power of the wireless transmission from the end unit. However, increasing the transmission power from the end unit requires additional power consumption and reduces the battery life of the power source provided with the end unit. Further, government regulations limit the power of radio transmissions output from the end unit. Another solution has been to improve the sensitivity of the coupler device. Improving the sensitivity of the coupler device is not always a simple task and depends mainly on the radio module quality. Another solution has been to provide the end unit with a multiple resonance antenna, which tunes the output of the end unit antenna to match for the conditions within the pit, i.e., water-filled or free air space.

According to an example of the present disclosure, a solution for loss of wireless connectivity between the end unit and the collector unit of an AMR system, particularly due to pit depth and the presence of standing water within a pit, is provided. The solution incorporates an electromagnetic coupler, which is a device that interacts with another electromagnetic device. Electromagnetic couplers are routinely used and can be found in many devices, such as wireless chargers, transformers, etc. The term “electromagnetic coupling” refers to the transfer of electromagnetic energy from a first point to a second point without a galvanic connection between the device located at the first point and another device located at the second point and through a medium, such as air, water, a human body, etc., or a combination or mixture of mediums.

A good electromagnetic coupling is measured by the amount of energy that is transferred from the first point to the energy that is received at the second point. For a transmitter located at point A (X₁, Y₁, Z₁) and a receiver located at point B (X₂, Y₂, Z₂), the coupling efficiency is defined according to the following Equation 1:

$$( 1 ) Coupling eff [ \% ] = 100 * \frac{Received energy at poin t B [ Watt ]}{Transferred energy from point A [ Watt ]}$$

### Coupler Device

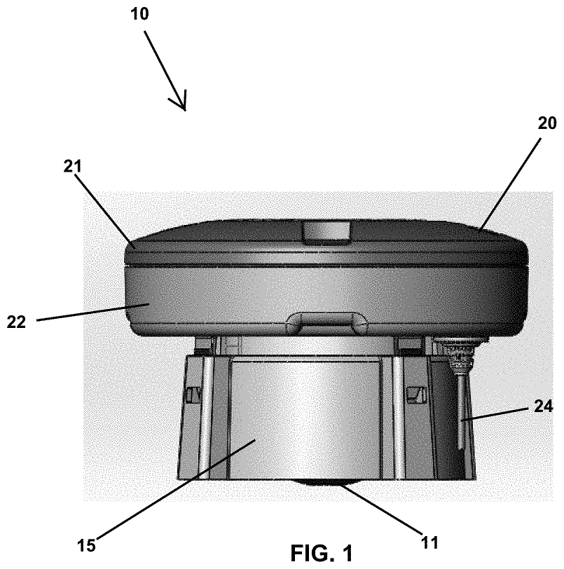

With reference to FIGS. 1-7, a coupler device 20 for a meter reading system is shown in accordance with an example of the present disclosure. The coupler device 20 is assembled on a register 11, which acts as an end unit of an AMR system, such that the coupler device 20 and the register 11 form a combined assembly 10.

As discussed above, the AMR system includes a plurality of end units, such as register 11, in communication with a plurality of collector units (not shown). The end units and collector units are linked via a communications network, which may be a wired network, but is more frequently a wireless communication network based upon combinations of lower power and higher power wireless communications, such as radio communications, or a combination of wired and wireless communications protocols. The communications network may also utilize different wireless communications protocols. According to an example of the present disclosure, at least a portion of the end units and the collector units of the AMR system includes a radio transceiver that is configured to transmit and receive radio frequency (RF) signals.

As shown in FIGS. 1-5, the register 11 is a sealed, closed device. The outer enclosure of the register 11 includes an upper lens cup 12 and a lower metal cup 14. The register 11 includes a main printed circuit board (PCB) with electronic components, such as a microcontroller, RF transceiver, antenna, batteries, etc. The register 11 is typically assembled directly on a utility meter. To that end, mounting components 15 may be provided to secure the register 11 on the structure of the water meter. As shown, the register 11 has a substantially cylindrical shape, although it is to be appreciated that the register 11 may have any configuration or shape found to be suitable to those having ordinary skill in the art in order to make the register 11 compatible with the structure of a particular utility meter. One such sealed register is disclosed in U.S. Pat. No. 6,819,292, which is hereby incorporated by reference.

As shown in FIGS. 1-7, the coupler device 20 includes a housing that defines a hollow interior 27. The hollow interior 27 of the housing is sealed to define a hollow air space within the housing that surrounds the electromagnetic coupler 23. The hollow interior 27 of the housing is sealed so as to prevent penetration of water into the hollow interior 27. According to one example of the present disclosure, the housing of the coupler device is formed from a polymeric material, such as ABS, PC, nylon, etc. It is to be appreciated that the housing may be formed from any material found to be suitable to those having ordinary skill in the art. The coupler device 20 is positioned on the register 11 of the meter reading system. An electromagnetic coupler 23 is positioned within the hollow interior 27 of the housing of the coupler device 20. The electromagnetic coupler 23 is configured to form an electromagnetic coupling with the register 11. The housing engages the register 11 to form a sealed gap 28 between the electromagnetic coupler 23 and the register 11.

According to the example, the register 11 has a cylindrical shape and the housing of the coupler device 20 has a substantially toroidal shape, such that the housing completely surrounds a perimeter of the register 11 at a point along a height of the register 11. As shown in FIGS. 1, 2, 6, and 7, the housing includes an upper cap 21 and a lower cap 22 that are sealingly engaged with each other to define the hollow interior 27 of the housing. According to one example of the disclosure, the upper cap 21 and the lower cap 22 have corresponding annular shapes and are mechanically connected and sealed with an O-ring or gasket. Alternatively, the upper cap 21 and the lower cap 22 may be connected and sealed by an adhesive or fused or welded together.

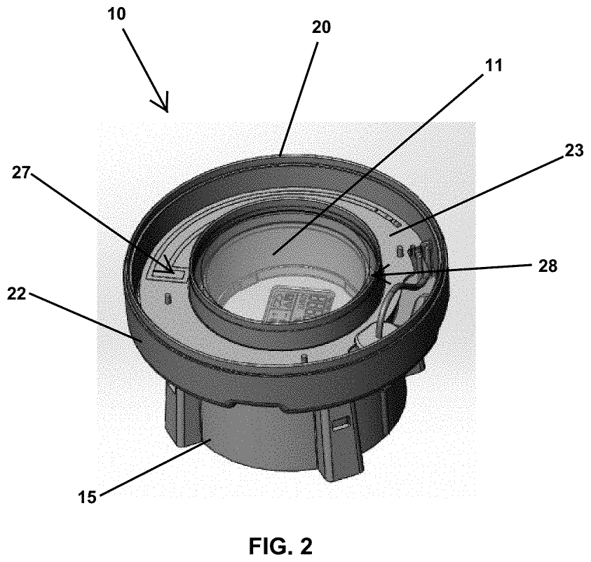

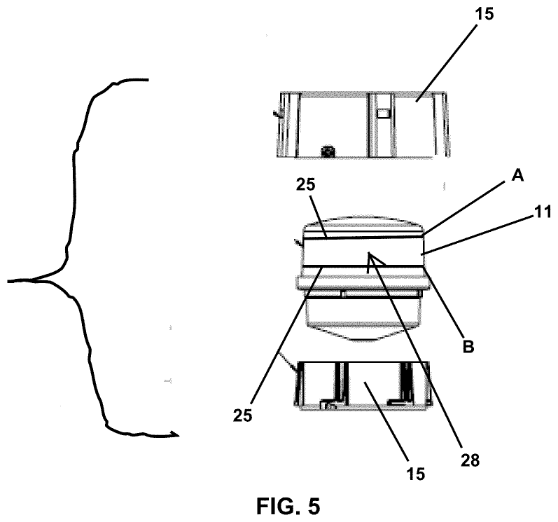

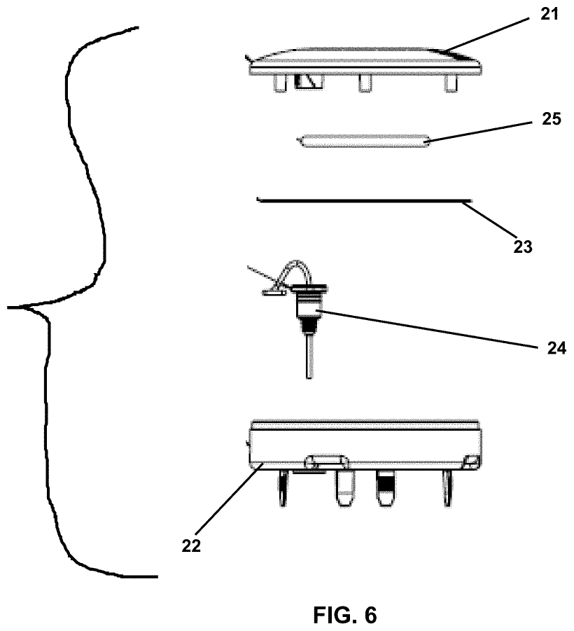

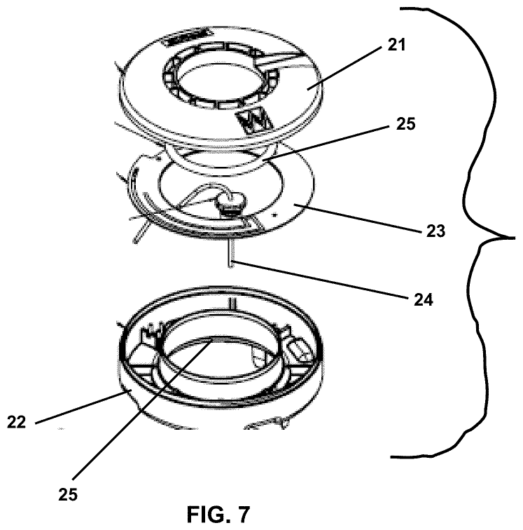

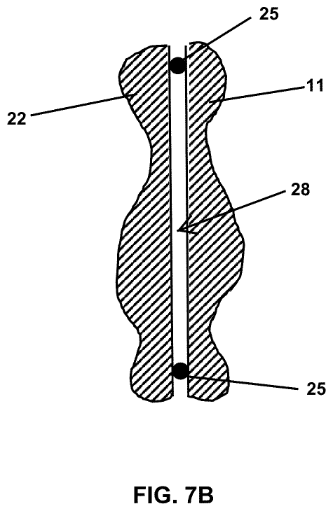

As shown in FIGS. 2-4, the toroidal shape of the housing defines an inner surface that sealingly engages an exterior of the register 11 to form the sealed gap 28. As shown in FIGS. 6 and 7, according to an example of the present disclosure, the inner surface of the housing is provided with one or more O-rings or sealing gaskets 25 to form the sealed engagement between the inner surface of the housing and the exterior surface of the register 11. Preferably, the O-rings 25 are provided at planes A and B so as to form watertight seals at A and B and to define the air gap 28 therebetween. See FIGS. 5 and 7B.

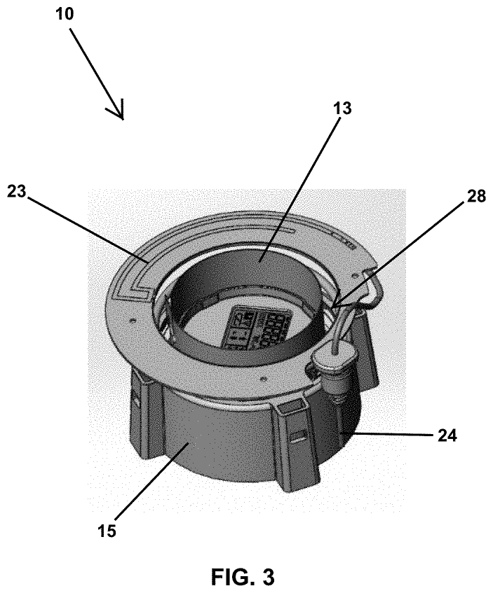

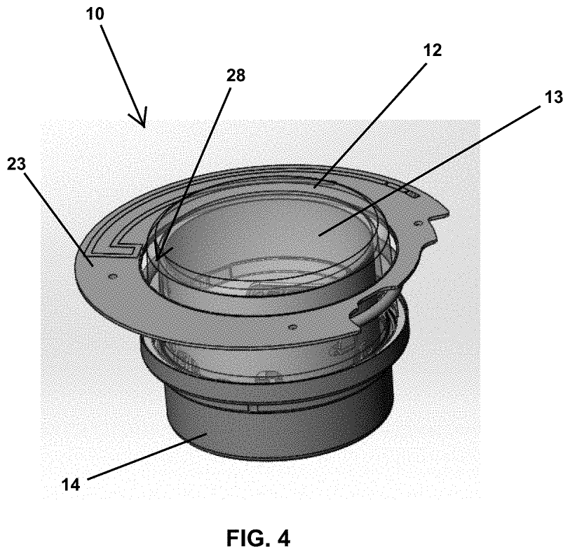

With reference to FIGS. 2-4, 6, and 7, the electromagnetic coupler 23 has an annular ring shape and is configured to extend within the hollow interior 27 of the housing completely around the register 11. The electromagnetic coupler 23 comprises a printed circuit board (PCB) with double-sided copper etching. The electromagnetic coupler 23 is arranged to match with the antenna 13 of the register 11 to form an electromagnetic coupling with the antenna 13. The sealed gap 28 formed by the engagement between the interior surface housing of the coupler device 20 and the exterior of the register 11 ensures that only air is present between the electromagnetic coupler 23 and the register antenna 13; i.e., no medium, such as water, can penetrate between the electromagnetic coupler 23 and the register antenna 13 due to the sealed engagement between the coupler device 20 and the register 11. According to the example, the coupler device 20 is arranged on the register 11 such that the electromagnetic coupler 23 surrounds the register antenna 13, as shown in FIGS. 3 and 4. The register antenna 13 has a substantially cylindrical configuration which, in combination with the annular shape of the electromagnetic coupler 23, results in a larger area to be coupled. Further, the looped configuration of the electromagnetic coupler 23 around the register antenna 13 results in a dipole arrangement, which catches all of the energy transmitted by the register antenna 13 for 360°.

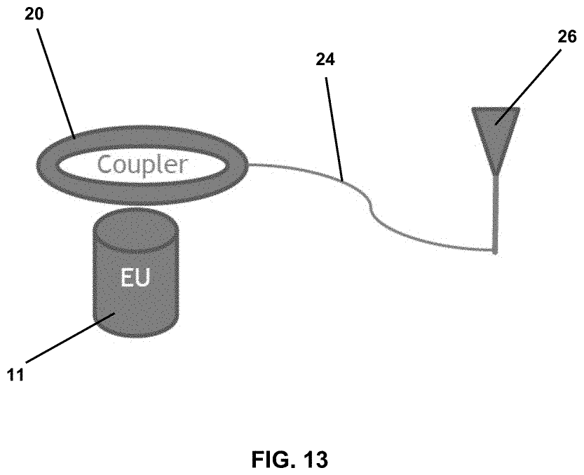

As shown in FIGS. 1-3, 6, and 7, the coupler device 20 may also include a coaxial cable 24 connected to the electromagnetic coupler 23 and extending from the housing of the coupler device 20. As shown in FIG. 13, the coaxial cable 24 may be used to connect the electromagnetic coupler 23 to an external antenna 26 mounted away from the combined assembly 10 of the register 11 and the coupler device 20. For instance, the external antenna 26 may be mounted at the top of the pit in which the register 11 and coupler device 20 are disposed. According to this example, the coupler device 20 is connected to the register 11 via the coupling between the register antenna 13 and the electromagnetic coupler 23. The coupler device 20 is further connected to the external antenna 26 via the coaxial cable 24. A signal transmitted from the transceiver of the register 11 via the register antenna 13 is coupled to the electromagnetic coupler 23 of the coupler device 20. After the coupling, the signal is propagated by the electromagnetic coupler 23 through the coaxial cable 24 to the external antenna 26 and then transmitted by the external antenna 26 to a collector unit. An amplifier may be included within the system at any point between the register 11 and the external antenna 26.

According to one example of the present disclosure, the electromagnetic coupler 23 comprises a passive antenna. Alternatively, the electromagnetic coupler 23 comprises an active antenna connected to a power source (not shown) disposed within the hollow interior 27 of the coupler device 20. According to another example of the present disclosure, the electromagnetic coupler 23 comprises a dual-band antenna that is able to form a frequency match with the antenna 13 of the register 11.

### Working Example

As discussed above, the register 11 incorporates the antenna 13 to transmit radio signals, which are received at the collector unit. To create a 100% efficient system, it is most likely that all the energy that is transmitted from the register 11 will be transferred to the collector unit (and vice versa). However, radio frequency signals tend to fade, scatter, and become diffracted due to the communication channel characteristics (topological features, medium properties, temperature). Regardless of whether the communication channel is static or dynamic, it is very difficult to change the channel characteristics.

Two main constraints in typical AMR systems are the installation of end units in a deep metering pit and changes of the surrounding medium within the metering pit due to the pit being initially empty and air-filled and then becoming filled with water, soil, etc. over time. When one or both of the above constraints occurs, the performance of the AMR system is negatively affected, and the communications link between the end unit within the pit and the collector unit becomes worse. Pit depth can vary from a few centimeters to 1-2 meters.

Installation of an end unit inside an underground pit affects the amount of energy transmitted from the end unit that can exit the pit at ground level compared to the amount of energy transmitted by an end unit located at ground level. The differences in transmitted power (as measured in decibel-milliwatts (dBm)) can vary from a few dBm to 10 dBm or more. A decibel-milliwatt (dBm) is the power ratio in decibels (dB) of the measured power reference to one milliwatt (mW) as per the following Equation (2):

$$( 2 ) P [ dBm ] = 10 * log 1 \; 0 \frac{P [ Watt ]}{1 mW}$$

Assuming transmission of 1 Watt and reception of 0.5 Watt (a power loss of 0.5 Watt), the power loss in dBm according to Equation (2) is as follows:

$$\begin{matrix}P [ dBm ] = 10 * log 10 \frac{1 [ Watt ]}{1 mW} = 30 dBm \\ P [ dBm ] = 10 * log 10 \frac{0.5 [ Watt ]}{1 mW} = 27 dBm\end{matrix}$$

The reduction of power by half is equal to a loss of 3 dBm. In circumstances where there is a 10 dBm loss in transmission power from the pit, due to pit depth or the presence of standing water in the pit around the end unit, only 20 dBm are being transmitted from the pit, and the power loss is converted from dBm to Watts, as follows:

$$\begin{matrix}P [ Watt ] = 1 mW * {10}^{\frac{P [ dBm ]}{10}} \\ P [ Watt ] = 1 mW * {10}^{\frac{20}{10}} = 100 mW\end{matrix}$$

As demonstrated above, when the end unit is configured to transmit at 1 Watt, only 100 mW (one-tenth of the expected transmission power) are transmitted from the pit at ground level due to losses caused by the pit depth and/or the presence of water within the pit. Accordingly, it is to be appreciated that the transmission energy lost due to pit depth and the presence of water is significant.

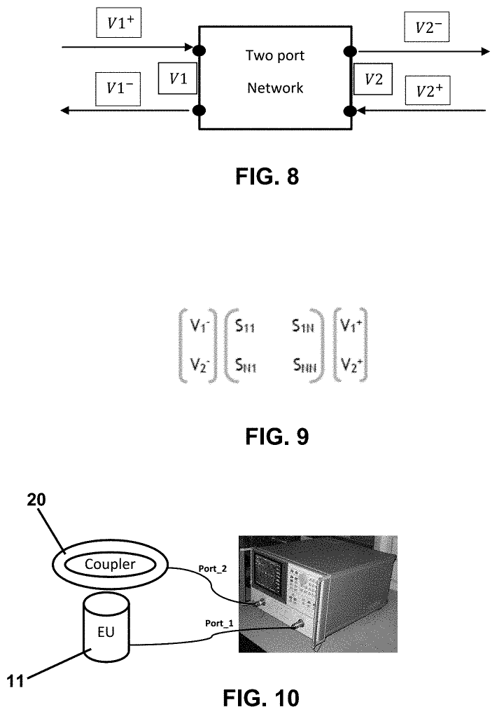

FIG. 8 illustrates the configuration of a two port network according to an example of the present disclosure. For an N-ports network where Vₙ⁺ is the amplitude of the voltage wave incident on port n and V⁻ is the amplitude of the voltage wave reflected from port n, the scattering matrix or [S] matrix is defined in relation to this incident and reflected in the voltage in the manner illustrated in FIG. 9. For a two port network, S₁₁ is the reflection coefficient seen at port 1 when port 2 is terminated in a match load, Z₀=50 ohm; and S₂₂ is the reflection coefficient seen at port 2 when port 1 is terminated in match load, Z₀=50 ohm. S₁₂ is the transmission coefficient from port 2 to port 1; and S₂₁ is the transmission coefficient from port 1 to port 2.

As discussed above, the end unit (register 11) includes a radio transceiver with an antenna 13, and the coupler device 20 includes the electromagnetic coupler 23 that collects energy transmitted by register antenna 13. With reference to FIG. 10, this arrangement can be modeled as a two port network. The end unit 11 includes the antenna 13 that is connected to a 50 ohm coaxial cable. The coupler device 20 is assembled on the end unit 11 and coupled to the antenna 13 of the end unit 11, which is also connected to a 50 ohm coaxial cable.

In order to assess the effectiveness of the electromagnetic coupling between the end unit 11 and the coupler device 20, the above-described two port network between the end unit 11 and the coupler device 20 was formed as a working example of the present disclosure, and the reflection coefficient at port 1 and port 2 was observed. The transmission coefficient from port 1 to port 2 was also observed. The transmission coefficient in decibel-milliwatts (dBm) is an indication of the power lost due to the coupling. The reflection coefficient is an indication of the level of matching between the antenna 13 of the end unit 11 and the electromagnetic coupler 23 of the coupler device 20.

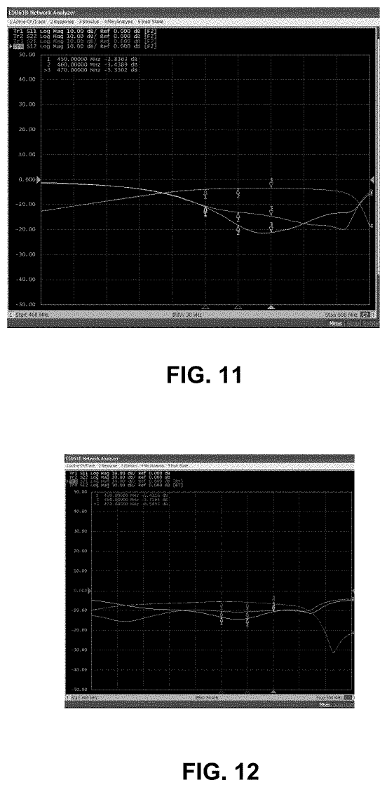

With reference to FIGS. 11 and 12, the S-parameters of the above-described two port network were measured. FIG. 11 is a chart showing the performance of the end unit/coupler device system in a free space; i.e., no water surrounding the end unit 11 and coupler device 20. As shown in FIG. 11, the measured S₁₁ and S₂₂ reflection coefficients are better than −10 dBm. The measured transmission coefficient S₂₁ is about −3.5 dBm, which represents the coupling losses between the end unit 11 and the coupler device 20. In terms of power, this means that a little more than half of the energy transmitted from the end unit 11 was lost.

FIG. 12 is a chart showing the performance of the end unit/coupler device system in a water-filled space. As shown in FIG. 12, the measured S₂₂ and S₂₁ reflection coefficients indicate a good match condition. The measured transmission coefficient S₂₁ has reduced even further to −6 dBm due to the presence of water surrounding the end unit/coupler device system. In an in-use environment, when the pit is filled with water the transmission power from the end unit 11 without the coupler device 20 could be degraded by more than 10 dBm, even though S₂₁ and S₁₁, S₂₂ could be different from the number indicated in FIG. 12. Accordingly, there is still a considerable increase in total transmitted power with the coupler device 20 being present in comparison to without the coupler device 20. The features of the end unit/coupler device system, such as a good electromagnetic coupling between the end unit 11 and the coupler device 20 and the coupler device 20 including a mechanical closure that minimizes the effect of water on the end unit/coupler device system, help to achieve this performance. Performance may be further improved by providing the end unit 11 with an antenna 13 that is a multiple resonance antenna capable of matching with or without the presence of surrounding water and by connecting the coupler device 20 to an external antenna 26, as discussed above with reference to FIG. 13. One example a multiple resonance antenna suitable for use in the end unit 11 is disclosed in United States Patent Application Publication No. 2016/0187157, which is hereby incorporate by reference in its entirety.

It is to be understood that the invention may assume various alternative variations and step sequences, except where expressly specified to the contrary. It is also to be understood that the specific devices and processes illustrated in the attached drawings, and described in the specification, are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that, to the extent possible, one or more features of any embodiment or aspect can be combined with one or more features of any other embodiment or aspect.

The invention claimed is:

1. A coupler device for a meter reading system, comprising:
a housing defining a hollow interior, the housing being configured to be positioned on an end unit of the meter reading system; and
an electromagnetic coupler positioned within the hollow interior of the housing, the electromagnetic coupler being configured to form an electromagnetic coupling with the end unit,
wherein the housing is configured to engage the end unit to form a sealed gap between the electromagnetic coupler and the end unit.

2. The coupler device according to claim 1, wherein the hollow interior of the housing is sealed.

3. The coupler device according to claim 1, wherein the housing has a substantially toroidal shape and is configured to be positioned on the end unit so as to surround the end unit.

4. The coupler device according to claim 3, wherein the housing comprises an upper cap and a lower cap, and the upper cap and the lower cap are sealingly engaged to each other to define the hollow interior.

5. The coupler device according to claim 3, wherein the toroidal shape of the housing defines an inner surface of the housing and the inner surface of the housing is configured to sealingly engage the end unit to form the sealed gap.

6. The coupler device according to claim 3, wherein the electromagnetic coupler has an annular ring shape and is configured to extend within the hollow interior of the housing completely around the end unit.

7. The coupler device according to claim 1, further comprising a coaxial cable connected to the electromagnetic coupler and extending from the housing, wherein the coaxial cable is configured to place the electromagnetic coupler in communication with an external antenna.

8. The coupler device according to claim 1, wherein the electromagnetic coupler comprises a passive antenna.

9. The coupler device according to claim 1, wherein the electromagnetic coupler comprises an active antenna.

10. The coupler device according to claim 1, wherein the electromagnetic coupler comprises a dual-band antenna configured to form a frequency match with an antenna of the end unit.
